(19) United States
(12) Patent Application Publication
(10) Pub. No.: US 2011/0049184 A1
(43) Pub. Date: Mar. 3, 2011

(54) PACKAGE PROVIDED WITH LIQUID POURING NOZZLE

(75) Inventor: Katsunori Futase, Niigata (JP)

(73) Assignee: YUSHIN CO., LTD., Niigata (JP)

(21) Appl. No.: 12/989,249

(22) PCT Filed: Apr. 22, 2009
(86) PCT No.: PCT/JP2009/058424

§ 371 Date: Oct. 22, 2010

(30) Foreign Application Priority Data
May 12, 2008 (JP) 2008-124946

(51) Int. Cl. B67D 7/06

(52) U.S. Cl. 222/92

(57) ABSTRACT

There is provided a package bag provided with a liquid pouring nozzle wherein permanent deformation of a pouring path for a packing material of the liquid pouring nozzle in a swollen direction is prevented surely to completely prevent accidental invasion of air into a package bag main body in the pouring of the packing material but also the self-sealing one-way function can be sufficiently developed in the pouring stop of the packing material. The package bag according to the invention is characterized in that the liquid pouring nozzle is constructed by laying front and rear laminate films, each of which films comprising a base film layer and a high-melting sealant layer and a low-melting sealant layer sandwiching the base film layer therebetween so as to face the high-melting sealant layers to each other and fusion-joining them at their peripheral portions other than base end sides to each other, and the base end portion of the liquid pouring nozzle is fusion-joined to a sealant layer on an inner surface of a soft package bag main body through low-melting sealant layers on the outer surface of the nozzle at a posture of protruding the nozzle from a side portion of the soft package bag main body, and also in that the opposed high-melting sealant layers in the base end portion of the liquid pouring nozzle are temporarily fused to each other.

### TECHNICAL FIELD

This invention relates to a package bag provided with a liquid pouring nozzle. Particularly, the invention proposes a package bag in which a liquid pouring nozzle made from a soft thermoplastic thin laminate film can surely develop a one-way function even if a liquid packing material heat-sterilized or the like at about 50-100° C. is filled and packed in the package bag.

### BACKGROUND ART

As the conventional package bag having a liquid pouring nozzle, there is a package bag provided with a liquid pouring nozzle having such a one-way function that the pouring of a liquid packing material such as seasoning, wine, Japanese liquor, soup, dressing or others is stopped and at the same time the opening port is automatically closed to prevent invasion of air into the package bag as disclosed, for example, in JP-A-2005-15029 and JPA-2005-59958.

The conventional package bag with the liquid pouring nozzle is formed by fusion-joining a sealant layer, which is an outermost layer as a base end portion of the liquid pouring nozzle, to an inner surface of a soft package bag main body in a side portion or a top portion of the package bag main body. The liquid pouring nozzle is comprised of a thermoplastic uniaxially-stretched or biaxially-stretched base film layer and sealant layers laminated thereon at a sandwiched state. For instance, it is formed by laying front and rear laminate films or a single laminate film folded at its central portion so as to face one-side sealant layers to each other and fusing peripheral portions thereof other than its base end side to each other.

The liquid pouring nozzle conducts the pouring of a packing material from the bag without taking air into the package bag and has a function that the pouring of the packing material is stopped due to the shrinking or collapsing deformation of a package bag main body made from a soft film corresponding to the pouring of the packing material in the bag as well as the wetting of the inner surface of the liquid pouring nozzle with the packing material and at the same time the pouring port is automatically closed to surely prevent the invasion of air into the package nag, or a self-sealing one-way function. Moreover, the one-way function of the liquid pouring nozzle can develop a high one-way effect through a capillary action of a liquid packing material as the laminate film constituting the nozzle is high in the flatting property (flatness) and excellent in the wettability with the liquid packing material retaining between the laminate films.

The package bag with the liquid pouring nozzle needs no cap or the like for closing the pouring port and can be manufactured simply. In the package bag with the liquid pouring nozzle, the integral formation of the liquid pouring nozzle and the package bag main body or post fusion joining of the liquid pouring nozzle to the package bag main body can be conducted always surely and easily.

### DISCLOSURE OF THE INVENTION

### Problems to be Solved by the Invention

When the liquid packing material heated to about 50-100° C. for sterilization or the like is filled and packed in the conventional package bag through heat-sealing before the cooling to substantially a room temperature, since the liquid pouring nozzle is comprised of a soft thin laminate film made from a thermoplastic resin, a pouring path portion of the packing material is swollen due to the influence of heat and hydraulic pressure of the packing material invaded in the pouring nozzle particularly at a fallen posture of the package bag to bring about a large permanent deformation (iron effect or shape-memory effect).

As a result, the pouring path portion of the liquid pouring nozzle is at an opened state resulting from the permanent deformation of the laminate film, so that it is difficult to sufficiently prevent the invasion of air into the package bag main body and also there is a problem that the self-sealing one-way function can not be developed efficiently associated with the pouring stop of the packing material because the one-way function of the liquid pouring nozzle can develop the high effect due to the capillary action of the liquid packing material as the flattening property (flatness) of the pouring path portion becomes higher.

It is, therefore, an object of the invention to provide a package bag provided with a liquid pouring nozzle while maintaining the merits of the conventional technique as they are, wherein even when a liquid packing material of a heated state (50-100° C.) is filled and packed in the package bag and maintained at a fallen state, the permanent deformation of the pouring path for the packing material of the liquid pouring nozzle in a swollen direction is prevented surely to completely prevent accidental invasion of air into the package bag main body in the pouring of the packing material but also the self-sealing one-way function can be sufficiently developed in the pouring stop of the packing material.

According to the inventors' studies, it has been confirmed that the loss of the self-sealing one-way function due to the swollen deformation of the pouring path in the liquid pouring nozzle is remarkable when the heating temperature of the packing material is not lower than 50° C., while such an effect is not caused below 40° C. or at room temperature.

Therefore, the package bag according to the invention is useful when the liquid packing material is applied to fill-packing (hot pack) for heat-sterilizing at a temperature of not lower than 50° C. Of course, this package bag may be applied to a case that the liquid packing material is filled and packed at a temperature of lower than 50° C.

### Means for Solving Problems

The package bag provided with a liquid pouring nozzle according to the invention is characterized in that the liquid pouring nozzle is constructed by fusion-joining front and rear laminate films, each of which films comprising at least a base film layer and a sealant layer, so as to face sealant layers to each other, and the liquid pouring nozzle is formed at a posture of protruding from a side portion of a soft package bag main body, and the opposed inner sealant layers of the laminate films in a base end portion or a protruded base portion of the liquid pouring nozzle located at a boundary with the package bag main body are temporarily fused to each other, for example, at a strength corresponding to not more than a half of an original heat sealing strength.

The liquid pouring nozzle is constructed by laying a pair of front and rear laminate films, each of which films comprising a base film layer and high-melting sealant layers and low-melting sealant layer sandwiching the base film layer directly therebetween or indirectly through a middle layer, so as to face high-melting sealant layers located at the inside of the laminate films to each other and fusion-joining them at their peripheral portions other than base end sides to each other, and the base end portion of the liquid pouring nozzle is fusion-joined to a sealant layer on an inner surface of a soft package bag main body through low-melting sealant layers located at the outside of the laminate films on the outer surface of the nozzle at a posture of protruding the nozzle from a side portion of the soft package bag main body, frequently a side portion of an upper end portion thereof. In this case, the opposed high-melting sealant layers in the base end portion of the liquid pouring nozzle are temporarily fused to each other.

Alternatively, the liquid pouring nozzle is constructed by folding a single laminate film, which comprises a base film layer and high-melting sealant layer and low-melting sealant layer sandwiching the base film layer directly therebetween or indirectly through a middle layer, at its central portion so as to face high-melting sealant layers to each other, and fusion-joining peripheral portions of the folded laminate film other than base end sides to each other, and the base end portion of the liquid pouring nozzle is fusion-joined to a sealant layer on an inner surface of a soft package bag main body through low-melting sealant layers on the outer surface of the nozzle at a posture of protruding the nozzle from a side portion of the soft package bag main body, frequently a side portion of an upper end portion thereof. In this case, the opposed high-melting sealant layers in the base end portion of the liquid pouring nozzle are temporarily fused to each other.

The “base end portion” of the liquid pouring nozzle used herein may be a position corresponding to a fusion-joining position of the liquid pouring nozzle to the package bag main body, or a position somewhat biased from the above corresponding position toward the inside of the package bag main body, or a position somewhat biased from the above corresponding position toward the outside of the package bag main body. Even in any cases, it is necessary that a pouring path for a packing material having a length sufficient to develop the function inherent to the liquid pouring nozzle is left outside the temporary fused portion (side the protruding top of the liquid pouring nozzle).

At this moment, each of the high-melting sealant layer and the low-melting sealant layer may be made from a low-density polyethylene including a straight-chain, low-density polyethylene. Alternatively, the high-melting sealant layer may be made from a middle-density or high-density polyethylene, while the low-melting sealant layer may be made from a low-density polyethylene.

Moreover, the selection of high or low melting point in the same polyethylene can be realized, for example, by changing extrusion laminating condition and the like mutually in the lamination of the sealant layers.

The other package bag with the liquid pouring nozzle according to the invention is characterized in that the liquid pouring nozzle is formed by laying a pair of front and rear laminate films, each of which films comprising a base film layer and high-melting sealant layer and low-melting sealant layer sandwiching the base film layer directly therebetween or indirectly through one or more a middle layer, so as to face high-melting sealant layers located at the inside of the laminate films to each other and fusion joining them at their peripheral portions other than base end sides to each other, and integrally united to a soft package bag main body at its a posture of protruding from a side portion of an upper end portion thereof. In this case, the opposed high-melting sealant layers in the inner surface of the nozzle are temporarily fused at the protruding base portion of the liquid pouring nozzle from the soft package bag main body.

Alternatively, the liquid pouring nozzle is formed by folding a single laminate film, which comprises a base film layer and high-melting sealant layer and low-melting sealant layer sandwiching the base film layer directly therebetween or indirectly through a middle layer, at its central portion so as to face high-melting sealant layers to each other, and fusion-joining peripheral portions of the folded laminate film other than base end sides to each other, and integrally united to a soft package bag main body at a posture of protruding from a side portion of an upper end portion thereof. In this case, the opposed high-melting sealant layers in the inner surface of the nozzle are temporarily fused at the protruding base portion of the liquid pouring nozzle from the soft package bag main body.

The “base portion” of the liquid pouring nozzle from the soft package bag main body may be a position corresponding to a fusion-joining position of a side portion of the package bag main body or a position somewhat biased from the above corresponding position toward a protruding top side of the nozzle. Even in this case, it is necessary that a pouring path for a packing material having a length sufficient to develop the function inherent to the liquid pouring nozzle is left outside the temporary fused portion (at the side of the protruding top of the liquid pouring nozzle).

Moreover, the “temporary fusion” used herein can be realized by reducing at least one of heating temperature, pressurizing force and pressurizing time of a heat sealing means as compared with the case of forming a complete fusion-joined portion.

Even in these cases, the temporary fused portion is preferable to have a heat sealing strength of 0.3-3 (N/15 mm), particularly 0.5-2 (N/15 mm), more especially 0.7-1 (N/15 mm). Also, the temporary fused portion is preferable to have an opening load of 50-350 (N), particularly 80-300 (N), more especially 100-200 (N).

Also, it is preferable that when the packing material is poured through the liquid pouring nozzle by tilting the package bag main body, the inner surfaces of the laminate films at a wetted state due to the passing of the packing material are closed to each other by the capillary action through the residual packing material to develop one-way function of preventing the invasion of air.

Moreover, it is preferable that an SiO₂ deposit layer, a vinylidene chloride coating layer, an aluminum oxide coating layer, an Al deposit layer or a gas barrier layer made from a sputtering layer thereof is formed on at least one-side surface of the base film layer in the liquid pouring nozzle.

### Effect of the Invention

In the package bag provided with the liquid pouring nozzle according to the invention, the temporary fused portion having a heat sealing strength corresponding, for example, to not more than a half of an original heat sealing strength is disposed on the base end portion or the protruded base portion of the liquid pouring nozzle in the fusion-joining position of the liquid pouring nozzle to the package bag main body or in the vicinity of the boundary position to the package bag main body, and the flowing of the liquid packing material filled and packed in the package bag through the temporary fused portion toward the top side of the nozzle is surely prevented by the temporary fused portion. Thus, even if the liquid packing material is heated to 50-100° C., the proceeding of the packing material into the liquid pouring nozzle is prevented by the temporary fused portion, and hence a most part of the pouring path for the packing material is sufficiently protected from the permanent deformation in a direction of swelling the pouring path.

Therefore, a portion of the liquid pouring nozzle ranging from the temporary fused portion toward the top side can sufficiently develop the same function as the liquid pouring nozzle disclosed in JP-A-2005-15029 and JP-A-2005-59958, i.e. a self-sealing one-way function in the pouring stop of the packing material that the inside of the pouring path in the liquid pouring nozzle is always made to a remaining (retaining) wet state through the capillary action of the packing material in the bag by the stop of the pouring based on the returning of the package bag to the standup posture but also strongly closed to each other to completely prevent the invasion of air into the package bag main body.

The pouring of the packing material in the bag cooled substantially to room temperature from the package bag is carried out, for example, by applying a load in a thickness direction of the package bag to open the temporary fused portion and further breaking or cutting the top portion of the liquid pouring nozzle to form a pour opening port and tilting the package bag so as to turn the pour opening port downward.

At this moment, the fusion-joined portion of the package bag other than the temporary fused portion is heat-sealed at a strength larger by two times than that of the temporary fused portion, so that there is caused no accidental breakage in the fusion-joined portion even if a load required for opening the temporary fused portion is applied.

According to the invention, the temporary fused portion is formed in the base end portion of the liquid pouring nozzle, whereby a greater part of the liquid pouring nozzle is not subjected to the swelling deformation through the heated packing material in the bag and the invasion of air into the package bag main body associated with the pouring of the packing material in the bag can be prevented effectively.

Also, in the package bag formed by fusion-joining the liquid pouring nozzle to the package bag main body, when each of the front and rear laminate films in the liquid pouring nozzle comprises the base film and the high-melting sealant layer and low-melting sealant layer sandwiching the base film layer directly therebetween or indirectly through a middle layer, each of the high-melting sealant layer located in the inner surface of the liquid pouring nozzle and the low-melting sealant layer located in the outer surface thereof is made from a low-density polyethylene, or when the high-melting sealant layer is made from a middle-density or high-density polyethylene and the low-melting sealant layer is made from a low-density polyethylene, the temporary fused portion having a sealing strength as is expected can be disposed in the liquid pouring nozzle but also the required fusion joining can be attained simply and easily.

Further, when the high-melting sealant layer is made from a straight-chain, low-density polyethylene, a low-density polyethylene or a middle-density polyethylene, the fusion-joining strength inherent to the liquid pouring nozzle can be enhanced sufficiently.

As the other package bag according to the invention, the liquid pouring nozzle may be integrally united with the package bag main body. In this integrally united package bag, the temporary fused portion is formed in the base portion of the liquid pouring nozzle protruding from the soft package bag main body likewise the package bag comprised separately of the package bag main body and the liquid pouring nozzle, whereby the unintended invasion of air into the package bag main body can be prevented sufficiently even in both the pouring and the pouring stop of the liquid packing material in the package bag.

Even in this package bag and the aforementioned package bag, the heat sealing strength of the temporary fused portion is preferable to be a range of 0.3-3 (N/15 mm), particularly 0.7-1 (N/15 mm). When the heat sealing strength of the temporary fused portion is within this range, the accidental opening of the temporary fused portion is prevented, while this temporary fused portion can be opened nonrandomly without exerting upon the other fusion-joined portion.

That is, when the heat sealing strength of the temporary fused portion is less than 0.3 (N/15 mm), since the heat sealing strength is weak, there is a fear of causing the unintended opening of the temporary fused portion under a relationship between the liquid packing material and the inner volume of the bag or the like. While when the heat sealing strength of the temporary fused portion exceeds 3 (N/15 mm), a large load is required for opening the temporary fused portion, and hence there is a fear of causing the accidental action (breakage or opening) of the other fusion-joined portion and the like by such a load.

The opening load of the temporary fused portion is preferable to be a range of 50-350 (N), particularly 100-200 (N). In case of such an opening load, the breakage or the like of the other portions including the sealed portion is not caused in the opening of the temporary fused portion, and also the temporary fused portion is not opened accidentally during the transportation or operation.

When the opening load is less than 50 (N), if the package bags each filled with the packing material are piled one upon the other, there is a fear of opening the temporary fused portion in the lower package bag. While when the opening load exceeds 350 (N), or when the heat sealing strength is too high, there is a fear of causing the breakage or opening of the other fusion joined portion by the load for opening the temporary fused portion.

### BRIEF DESCRIPTION OF THE DRAWINGS

FIG. 1 is a partially enlarged plan view of a main part illustrating an embodiment of the invention;

FIG. 2 is an enlarged section view taken along a line II-I1 of FIG. 1;

FIG. 3 is an enlarged section view taken along a line III-I11 of FIG. 1;

FIG. 4 is a section view illustrating another embodiment of the invention;

FIG. 5 is a schematically front view illustrating a test method for opening a temporary fused portion; and

FIG. 6 is a graph showing a relation between sealing temperature and average sealing strength.

### EMBODIMENTS OF THE INVENTION

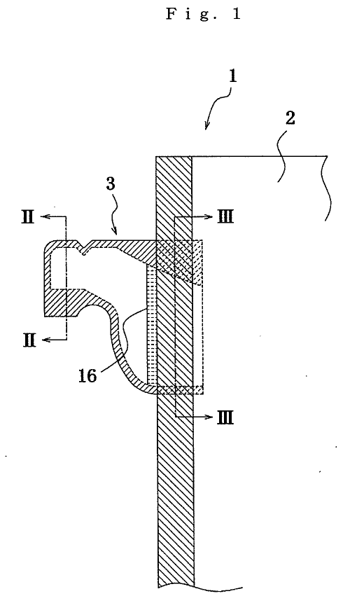

FIG. 1 is a partially enlarged plan view of a main part illustrating an embodiment of the invention. Moreover, the package bag of FIG. 1 is at a state of opening an upper end port. In this figure, numeral 1 is a whole of the package bag, numeral 2 a soft package bag main body, and numeral 3 a liquid pouring nozzle. The liquid pouring nozzle 3 is fusion-joined to the soft package bag main body 2 at a posture of protruding at an upper end portion of the package bag main body 2 toward the side thereof.

At this moment, the package bag main body 2 and the liquid pouring nozzle 3 are formed separately from each other, which are integrally united by fusion-joining an outer surface sealant layer in a base end portion of the liquid pouring nozzle 3 to an inner surface sealant layer of the package bag main body 2 as shown by slant lines downward to the right in the figure to constitute the package bag 1.

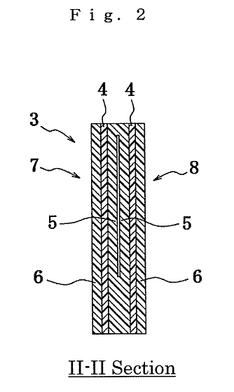

As a section taken along a line II-I1 of FIG. 1 is enlargedly shown in FIG. 2, the liquid pouring nozzle 3 is constituted with front and rear laminate films 7, 8 each comprising a uniaxially-stretched or biaxially-stretched base film layer 4 provided with a gas barrier layer made from NY, PET, OPP, SiO₂ deposited layer, vinylidene chloride coating layer, aluminum oxide coating layer, Al deposited layer or a sputtering layer of these materials (SiO₂, Al, Al₂O₃ or the like) and a high-melting sealant layer 5 and a low-melting sealant layer 6 sandwiching the base film layer 4 directly or indirectly therebetween, which are laminated at a directly sandwiching state in the figure. That is, the liquid pouring nozzle 3 is formed, for example, by piling two front and rear laminate films or folding a single laminate film at its central portion so as to face the high-melting sealant layers 5 to each other to shape front and rear laminate films 7, 8 and fusion-joining peripheral portions thereof other than base end sides as shown by slant lines downward to the left in FIG. 1, and at the same time punching out into a desired form with a mold or the like.

In the liquid pouring nozzle 3, it is preferable to dispose the gas barrier layer made of the deposited layer or coating layer on the base film layer 4 as mentioned above, whereby excellent steam impermeability, gas barrier properties and the like are given to the nozzle and the inner face of the liquid pouring nozzle is at a state always wetted with the residual (retaining) packing material in the bag and is strongly closed to each other (self-sealing one-way function), which can prevent the invasion of air into the package bag main body more effectively over the long term. The thickness of the gas barrier layer is preferable to be about 0.5 μm-20 μm.

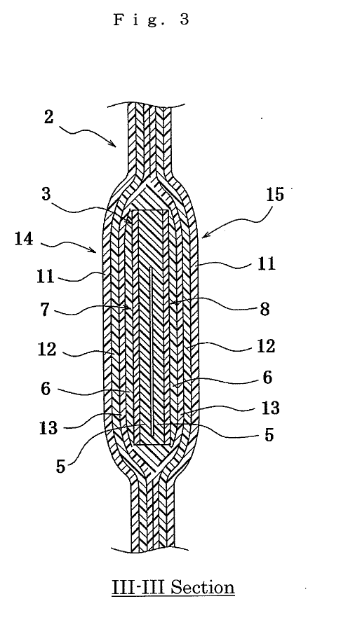

Also, as a section taken along a line of FIG. 1 is enlargedly shown in FIG. 3, the soft package bag main body 2 is formed, for example, by piling two front and rear laminate films or a single laminate film folded in its central portion so as to face sealant layers to each other to form front and rear laminate films 14, 15 each comprising a uniaxially- or biaxially-stretched base film 11 and a sealant layer 13 laminated on one-side surface of the base film layer 11 through a middle layer 12, and then fusion-joining peripheral portions thereof other than an opening side corresponding to the upper end side in FIG. 1.

The fusion-joining of the liquid pouring nozzle 3 to the package bag main body 2, or the manufacture of the package bag 1 is carried out by fusion-joining the low-melting sealant layer 6 on the outer surface of the nozzle to the sealant layer 13 of the package bag main body 2 at the base end portion of the liquid pouring nozzle 3 as shown in FIG. 3.

In this case, it is preferable that as the sealant layer 13 of the package bag main body 2 is used the same kind of sealant layer as the low-melting sealant layer 6 of the liquid pouring nozzle 3 for enhancing the heat sealing strength between the package bag main body 2 and the liquid pouring nozzle 3. Thus, when the liquid pouring nozzle 3 is fusion-joined to the package bag main body 2 through the low-melting sealant layer 6, the accidental fusion of the opposed high-melting sealant layers 5 in the inner surface of the liquid pouring nozzle 3 can be prevented sufficiently.

In the package bag 1, the high-melting sealant layers 5 in the pouring nozzle 3 are temporarily fused at the base end portion of the liquid pouring nozzle 3, i.e. a position corresponding to the position fusion-joining position of the liquid pouring nozzle 3 to the package bag main body 2 or a position biased from the corresponding position toward inside or outside of the package bag main body 2, at a position biased toward outside of the package bag main body 2 in FIG. 1, for example, at a sealing strength corresponding to not more than a half of primary heat sealing strength by selecting at least one of heating temperature, pressuring force and pressuring time as shown by dotted lines in the figure. In the figure, numeral 16 is a temporary fused portion.

Each of the high-melting sealant layer 5 and low-melting sealant layer 6 may be made from a low-density polyethylene including a straight-chain, low-density polyethylene. Also, the high-melting sealant layer 5 may be made from a middle-density or high-density polyethylene and the low-melting sealant layer 6 may be made from a low-density polyethylene.

The above will be described with respect to the package bag 1 comprised separately of the liquid pouring nozzle 3 and the soft package bag main body 2 with reference to FIG. 1. Moreover, the liquid pouring nozzle 3 and the package bag main body 2 may be integrally united with each other from the beginning.

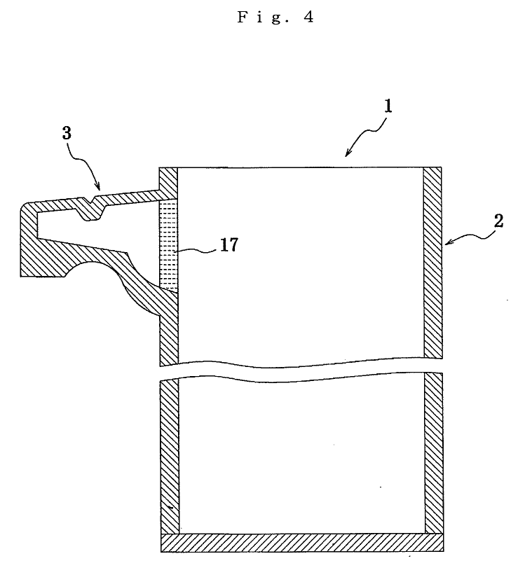

In a plan view of FIG. 4 is exemplified a package bag 1 formed by integrally uniting the liquid poring nozzle 3 with the package bag main body 2. Moreover, the package bag 1 of FIG. 4 is opened at its upper end. In this package bag 1, front and rear laminate films each comprising a uniaxially- or biaxially-stretched base film layer and a sealant layer laminated directly or indirectly on one-side surface of the base film layer, for example, two front and rear laminate films or a single laminate film folded in its central portion are piled so as to face the sealant layers to each other and thereafter their peripheral portions are fusion-joined to each other and then punched out with a mold or the like to form a soft package bag main body 2, which is integrally united with a liquid pouring nozzle 3 at a posture of protruding from a side part of the upper end portion of the bag.

Subsequently, the base portion of the liquid pouring nozzle 3 protruding from the soft package bag main body 2, an area shown by dotted lines in FIG. 4 corresponding to a fusing position in the side portion of the package bag main body 2 is temporarily fused at a sealing strength corresponding to not more than a half of original heat sealing strength, for example, by selecting at least one of heating temperature, pressuring force and pressuring time to form a temporary fused portion 17.

In both the package bag 1 comprised separately of the liquid pouring nozzle 3 and the package bag main body 2 and the package bag 1 formed by integrally uniting the liquid pouring nozzle 3 and the package bag main body 2, the heat sealing strength of the temporary fused portion 16, 17 is preferable to be a range of 0.3-3 (N/15 mm), especially 0.7-1 (N/15 mm). Also, the opening load of the temporary fused portion 16, 17 is preferable to be a range of 50-350 (N), especially 100-200 (N) irrespectively of the temporarily fusing width and the like.

### EXAMPLES

When a liquid pouring nozzle as shown in FIG. 1 is fusion-joined to a side part of an upper end portion of a soft package bag main body (NY15/PET12/LLDPE40), a base portion of the liquid pouring nozzle protruding from the soft package bag main body is temporarily fused by heating and pressing at a heat sealing temperature as a parameter under a cylinder pressure of 300 kPa for 3 seconds by means of a heat sealer provided with a cylinder. At this moment, the heat sealing strength (N/15 mm) of the temporary fused portion is measured with a tensile testing machine (TENSILON RTG-1300) under conditions of a tensile rate of 200 mm/min and a film width of 15 mm. The results are shown in Table 1.

Moreover, the structure of the laminate film in the liquid pouring nozzle is straight-chain low density polyethylene layer (low-melting sealant layer)/biaxially-stretched polyethylene terephthalate layer/straight-chain low density polyethylene layer (high-melting sealant layer).

TABLE 1

| | Sealing temperature (° C.) | | | | | |
|---|---|---|---|---|---|---|
| | 106 | 108 | 110 | 112 | 114 | 116 |
| Average | 0.27 | 0.36 | 0.44 | 0.64 | 1.79 | 4.61 |
| sealing | | | | | | |
| strength | | | | | | |
| (N/15 mm) | | | | | | |

* Measuring method: according to JIS E0236 (1996)

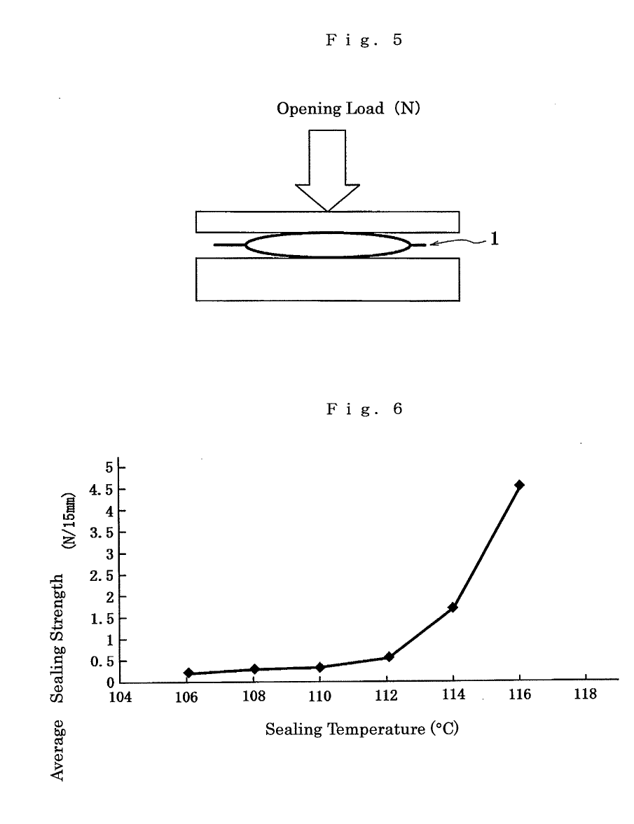

Next, in a package bag formed by integrally uniting a liquid pouring nozzle with a soft package bag main body of 200 mm in longitudinal size and 125 mm in width size as shown in FIG. 4, a temporary fused portion 17 is formed in a base end portion of the liquid pouring nozzle and 300 ml of water is filled and packed in the package bag. The package bag is pressed under a condition that a contact area is about 0.0135 m² as shown in FIG. 5, during which an opening load (N) and pressure (kPa) of the temporary fused portion 17 are measured. The results are shown in Table 2.

TABLE 2

| | Sealing temperature (° C.) | | | | | |
|---|---|---|---|---|---|---|
| | 106 | 108 | 110 | 112 | 114 | 116 |
| Opening | 43.56 | 54.12 | 78.48 | 171.68 | 274.68 | 402.21 |
| load (N) | | | | | | |
| Opening | 3.23 | 4.01 | 5.81 | 12.72 | 20.35 | 29.79 |
| pressure | | | | | | |
| (kPa) | | | | | | |

5

As seen from the results of Table 2, the opening load and pressure are changed in proportion to the sealing temperature. That is, it can be seen that the temporary fused portion 17 can be opened under an optional opening pressure by adjusting a sealant resin and a sealing temperature for the temporary fused portion 17.

### INDUSTRIAL APPLICABILITY

The invention is effective when being applied to a package bag provided with a liquid pouring nozzle having a self-sealing one-way function, but is useful as a temporary fusion technique for a package bag for liquid in which an opening shape is changed by permanent deformation of a laminate film.

1-7. (canceled)

8. A package bag provided with a liquid pouring nozzle, characterized in that the liquid pouring nozzle is constructed by fusion-joining front and rear laminate films, each of which films comprising at least a base film layer and a sealant layer, so as to face sealant layers to each other, and the liquid pouring nozzle is formed at a posture of protruding from a side portion of a soft package bag main body, and the opposed inner sealant layers of the laminate films in a base end portion or a protruded base portion of the liquid pouring nozzle located at a boundary with the package bag main body are temporarily fused to each other.

9. A package bag provided with a liquid pouring nozzle according to claim 8, wherein the liquid pouring nozzle is constructed by laying a pair of front and rear laminate films, each of which films comprising a base film layer and high-melting sealant layer and low-melting sealant layer sandwiching the base film layer directly therebetween or indirectly through a middle layer, so as to face high-melting sealant layers located at the inside of the laminate films to each other and fusion-joining them at their peripheral portions other than base end sides to each other, and the base end portion of the liquid pouring nozzle is fusion-joined to a sealant layer on an inner surface of a soft package bag main body through low-melting sealant layers located at the outside of the laminate films on the outer surface of the nozzle at a posture of protruding the nozzle from a side portion of the soft package bag main body.

10. A package bag provided with a liquid pouring nozzle according to claim 8, wherein the liquid pouring nozzle is constructed by folding a single laminate film, which comprises a base film layer and high-melting sealant layer and low-melting sealant layer sandwiching the base film layer directly therebetween or indirectly through a middle layer, at its central portion so as to face high-melting sealant layers to each other, and fusion-joining peripheral portions of the folded laminate film other than base end sides to each other, and the base end portion of the liquid pouring nozzle is fusion-joined to a sealant layer on an inner surface of a soft package bag main body through low-melting sealant layers on the outer surface of the nozzle at a posture of protruding the nozzle from a side portion of the soft package bag main body.

11. A package bag provided with a liquid pouring nozzle according to claim 9, wherein each of the high-melting sealant layer and the low-melting sealant layer is made from a low-density polyethylene.

12. A package bag provided with a liquid pouring nozzle according to claim 9, wherein the high-melting sealant layer is made from a middle-density or high-density polyethylene and the low-melting sealant layer is made from a low-density polyethylene.

13. A package bag provided with a liquid pouring nozzle according to claim 8, wherein a heat sealing strength of the temporary fused portion is 0.3-3 (N/15 mm).

14. A package bag provided with a liquid pouring nozzle according to claim 8, wherein an opening load of the temporary fused portion is 50-350 (N).

15. A package bag provided with a liquid pouring nozzle according to claim 8, wherein when a packing material is poured through the liquid pouring nozzle by tilting the package bag main body, the inner surfaces of the laminate films at a wetted state due to the passing of the packing material are closed to each other by capillary action through the residual packing material to develop one-way function of preventing the invasion of air.

16. A package bag provided with a liquid pouring nozzle according to claim 8, wherein the liquid pouring nozzle is formed by laying a pair of front and rear laminate films, each of which films comprising a base film layer and high-melting sealant layer and low-melting sealant layer sandwiching the base film layer directly therebetween or indirectly through a middle layer, so as to face high-melting sealant layers located at the inside of the laminate films to each other. and fusion-joining them at their peripheral portions other than base end sides to each other, and integrally united to a soft package bag main body at a posture of protruding from a side portion of an upper end portion thereof.

17. A package bag provided with a liquid pouring nozzle according to claim 8, wherein the liquid pouring nozzle is formed by folding a single laminate film, which comprises a base film layer and high-melting sealant layer and low-melting sealant layer sandwiching the base film layer directly therebetween or indirectly through a middle layer, at its central portion so as to face high-melting sealant layers to each other, and fusion-joining peripheral portions of the folded laminate film other than base end sides to each other, and integrally united to a soft package bag main body at a posture of protruding from a side portion of an upper end portion thereof.

18. A package bag provided with a liquid pouring nozzle according to claim 16, wherein a heat sealing strength of the temporary fused portion is 0.3-3 (N/15 mm).

19. A package bag provided with a liquid pouring nozzle according to claim 16, wherein an opening load of the temporary fused portion is 50-350 (N).

20. A package bag provided with a liquid pouring nozzle according to claim 16, wherein when a packing material is poured through the liquid pouring nozzle by tilting the package bag main body, the inner surfaces of the laminate films at a wetted state due to the passing of the packing material are closed to each other by capillary action through the residual packing material to develop one-way function of preventing the invasion of air.
